(19) United States
(12) Patent Application Publication
(10) Pub. No.: US 2008/0193674 A1
(43) Pub. Date: Aug. 14, 2008

(54) Production of a Gas-Tight, Crystalline Mullite Layer by Using a Thermal Spraying Method

(76) Inventors: Roberto Siegert, Miami, FL (US); Silke Latzel, Konz (DE); Ralf Hansch, Bad Muenter-Abeweiter (DE); Detlev Stover, Niederzier (DE); Robert Vassen, Herzogenrath (DE)

Correspondence Address: K.F. ROSS P.C., 5683 RIVERDALE AVENUE, SUITE 203 BOX 900, BRONX, NY, 10471-0900, US

(21) Appl. No.: 11/664,536

(22) PCT Filed: Sep. 17, 2005
(86) PCT No.: PCT/DE2005/001641

§ 371 Date: Feb. 28, 2008

(30) Foreign Application Priority Data
Sep. 30, 2004 (DE) 10 2004 047 453.2

(51) Int. Cl. H05H 1/24

(52) U.S. Cl. 427/576

(57) ABSTRACT

The invention relates to a method for producing a tight crystalline mullite layer on a metallic and/or ceramic substrate by using the plasma spraying technique. To this end, a sol containing mullite precursors with a proportion of 2 to 25% by weight with regard to the oxides (3 Al₂O₃/2 SiO₂) is used as a spraying additive. This method is carried out under atmospheric conditions, and the sol is injected with a focussed jet and with an overpressure of at least one I bar into the plasma flame. An additional compacting of the layer can be advantageously effected by repeatedly passing over the layer with the plasma flame. The method is particularly suited for applying a gas-tight crystalline mullite layer to a steel substrate.

The invention relates to a thermal spray process for producing dense, crack-free coatings on a metallic and/or ceramic substrate, in particular a crystalline mullite coating (3Al₂O₃.2SiO₂) on a metallic or non-metallic mold or component.

### PRIOR ART

The literature describes various coating techniques that are suitable for producing dense coatings on a metallic and/or ceramic substrate. These coatings normally act as heat-insulation for substrates that are subjected to high operating temperatures, such as for example gas turbine blades. Frequently, in addition to pure heat insulation, such coatings also protect against environmental influences, in particular corrosion. A coating that fulfills this dual function is frequently called a TEBC (thermal/environmental barrier coating).

Mullite (3Al₂O₃.2SiO₂), for instance, is a material that is suitable for a TEBC.

Among the known processes for applying TECB coatings to a substrate are thermal spray techniques such as the sol-gel process, which will be described in greater detail in the following.

I. Thermal Spray Processes

Thermal spray processes include those processes in which powdery spray additives are melted within or outside of spray devices and spun onto prepared substrate surfaces. The surfaces of the substrate are not melted. The spray coatings can be applied in liquid or plastic state from spray additives. Moreover, specific coating properties can be attained using additional thermal or mechanical post-treatments or by sealing.

In-thermal spray-processes, a distinction is made between low-energy flame spraying and arc spraying processes and high-energy plasma spray variants.

Plasma spraying is used wherever materials are to be used whose melting points are so high that the flame spraying temperature is normally not sufficient for melting the particles. By applying the particles at a high speed, it is possible to produce in particular ceramic coatings with low porosity.

Thermal spraying processes are distinguished by relatively high deposition rates and a low amount of energy added to the basic material. They are used in particular in the fields of heat, wear, and corrosion protection. Adhesion of the coating is highly dependent on the combination of materials, pretreatment, and the particular process.

The particle size of powders normally used is between 20 and 40 mm. Smaller particles generally lead to blockages in the injection nozzles. The coatings to be produced with them have correspondingly thin coating thicknesses of at least 50 to 100 mm, corresponding to 2 to 5 particle layers.

As long as a suspension or solution is used for the spray additive instead of powder, so-called SPS. (suspension plasma spraying) is used. In addition, there is SPPS (solution precursor plasma spraying) in which the solvent evaporation, pyrolysis, and subsequent crystallization occurs en route or on the substrate itself. The advantage of suspension plasma spraying is the smaller particle sizes that can be used. However, the solid content to be used can be limited by stabilization of the particles in the suspension. When the-concentration of solids is too high, the particles agglomerate within the suspension and as a rule thus produces disadvantageously uneven application on the substrate.

In general the plasma spray process has the disadvantages of segmentation cracks that occur in the deposited coating and deposition of amorphous portions. Furthermore, frequently there are adhesion problems between the substrate and the deposited coating if they have different thermal expansion coefficients.

U.S. Pat. No. 6,296,909 for instance describes a process in which crack-free mullite coatings are applied to a ceramic substrate. In the thermal spray process, the mullite particles used are heated to temperatures that are at least-greater than the peritectic temperature of the mullite and the applied mullite coating is then moderately cooled.

In order to prevent the portion of amorphously deposited mullite in an applied mullite coating from being to high, Kang N. Lee et al, J. Am. Ceram. Soc., 79[3] 620-626 (1996) suggests heating the substrate during the deposition procedure to temperatures that are greater than the crystallization temperature of the mullite.

A process for coating a ceramic substrate with mullite is also suggested in U.S. Pat. No. 5,391,404 where the substrate is heated during flame spraying to temperatures greater than 800° C. This is meant to ensure that the melted mullite material immediately crystallizes out on the substrate when it cools.

Alternative processes for applying a mullite coating to a SiC/SiC composite are for instance CVD (chemical vapor deposition).

II. Sol-Gel Process

The sol-gel process is a process for applying thin coatings. In the sol-gel process, the amorphous compound of a solid (gel) forms from a liquid sol due to the loss of solvent and the formation of a three-dimensional network. Organic metal precursors in particular are used for creating these structures.

Functionality can be significantly expanded by including additional organic groups. In addition, there is the option of embedding nanoparticles (<50 nm) into these structures, this enabling additional novel material variants.

The starting compounds are applied to the substrate by spraying, dipping, or spinning so that even inside surfaces and bores can be coated. The drying temperatures range from 80° C. to 150° C.

In the manufacture of coatings using the sol-gel process, the additional sintering step is disadvantageous; in some circumstances it can lead to damage in the substrate and to the opportunity for cracks to form due to volume contractions when the applied coating crystallizes out. Furthermore, as a rule only thin coatings are possible per application because otherwise more cracks generally form when the organic compounds are expelled. On the other hand, the sol-gel process is advantageously suited for producing extremely thin coatings. For instance, an applied 250 nm-thick coating normally has a coating thickness of approx. 50 nm after drying and sintering.

Yamamoto et al, Journal of Material Science Letters, 19 (2000) pages 1053-1055 describes applying thin mullite coatings to a SiC substrate, the dried coating having a coating thickness of 1.0 mm.

Furthermore known from the literature is a process where fully stabilized zirconium oxide is initially produced using a sol-gel process as a spray product for plasma spraying. The sol-gel process offers the advantage that it can be used to produce free-flowing powder having a uniform spherical geometry. The mean particle sizes can be adjusted between 10 and 100 nm (V. Belov, I. Belov l. Harel; J. Am. Ceram. Soc., 80(4) 982-90 (1997).

When using-mullite in the past, there have been problems particularly in applying the coating to a steel substrate. Mullite (α=4.5*10⁻⁶/K) and steel (α=17*10⁻⁶/K) have very different thermal expansion coefficients. Therefore the coating from powder-based plasma spraying frequently flakes off.

### OBJECT AND SOLUTION

The object of the invention is to provide a process with which in particular mullite can be applied as a crack-free, gas-tight, and crystalline coating to a metallic and/or ceramic, substrate, in particular to steel. The coating should adhere well even at high temperatures up to 1200° C.

The object is attained using a process in accordance with the main claim. Dependent claims-contain advantageous embodiments.

### SUBJECT-MATTER OF THE INVENTION

In the framework of the invention it was found that crystalline and gas-tight mullite coatings can be produced on a metallic and/or ceramic substrate, in particular by using very fine particles. Average particle sizes of less than 10 mm are less available commercially, but can be used in pure plasma spraying processes. In producing such fine particles using a sol-gel process, as is known from the literature for YSZ, and in use in a suspension spraying process, the quantity of solids is disadvantageously limited by the agglomeration of particles that occurs in the suspension.

The invention overcomes these disadvantages in that it discloses a process for applying mullite in which a sol is used directly as spraying material (feedstock) in a plasma spraying process rather than a powder or suspension. A solid content of up to 25 wt. % can be advantageously set for the sol. The particle size is adjusted to between 3 and 30 nm, in particular between 5 and 15 nm, depending on the sol parameters.

Depending on the number of transitions, coating thicknesses between 1 μm and a few mm can be produced with the inventive plasma spray. The minimum coating thickness is determined inter alia by the particle size, but also by the required sol quantity and the spraying distance, as well as the travel speed and the overlapping of the individual tracks. Thus a theoretical monolayer of particles having a diameter of 900 nm could be obtained using a single pass. However, in practice a coating will have a minimum coating thickness of at least 1 to 2 μm. The process imposes practically no upward limits in terms of the coating thickness. It has been demonstrated that the use of sols with a higher solid content up to 20 wt. % or even multiple passes lead to undisturbed crystalline, crack-free coatings into the mm range.

### SPECIFIC DESCRIPTION

In the following the subject-matter of the invention will be explained in greater detail using an illustrated embodiment; however, this does not limit the subject-matter of the invention.

A VA steel substrate is held on a water-cooled substrate mount. For the coating, a modified Sulzer Metco Company Triplex 1 burner is used that is equipped with an injector. The latter is aligned relative to the horizontal axis of the plasma flame at an angle α=600 outside of the burner. The diameter of the injector aperture is 0.2 mm. The sol is injected at an overpressure of 1 bar. The distance between the burner aperture and the substrate is 70 mm. The coating is applied under a normal atmosphere (atmospheric plasma spraying) in a plurality of overlapping layers. It was possible to attain an improvement in the coating surface using another pass over the specimen with the plasma flame, but without adding sol.

A sol made of a tetraethylene orthosilicate TEOS, an organic silicon precursor, and an aluminum nitrate, as well as acetyl acetone and an α-resistant carboxylic acid, e.g. acetic acid or propionic acid, is used for the spraying material. A solids content of approx. 5 wt. % mullite relative to the oxides (3Al₂O₃.2SiO₂) is set. The sol produced in this manner can advantageously be stored under normal conditions and has long-term stability. Normally particle sizes of approx. 5 to 20 nm are present in the sol-gel precursor, depending on the age of the sol. The sol from the mullite precursors reacts to mullite within the plasma flame. Application of the resultant fine mullite particles advantageously leads to a crystalline and gas-tight coating, even at low spraying temperatures.

A few spraying parameters for applying a mullite coating to a steel substrate are described in the following. Sol A has an Al₂O₃ content of 65 wt. % and a SiO₂ content of 35 wt. %. Sol B, with an Al₂O₃ content of 75 wt. % and a SiO₂ content of 28 wt. %, converts to the normal composition of mullite. Depending on the process parameters, the coating is applied with a mean coating thickness between 1.3 and 4.2 mm with 16 or 30 layers.

The sol is added to the plasma flame with an overpressure of at least 1 bar. An angle of approx. 60° has proven advantageous.

The substrate is heated only by the plasma flame. In general there is no further posttreatment. However, another pass with the plasma flame can lead to better coating surface quality.

1. A process for producing a dense, crystalline mullite coating on a metallic and/or ceramic substrate using the plasma spraying technique,
characterized in that
a sol including mullite precursors is used for a spray additive.

2. The process in accordance with preceding claim 1 wherein the plasma spraying is performed under atmospheric conditions.

3. The process in accordance with claim 1 wherein the sol is injected into the plasma flame with a focused beam.

4. The process in accordance with claim 1 wherein the sol is injected into the plasma flame at an overpressure of at least 1 bar.

5. The process in accordance with claim 1 wherein, after the coating has been deposited, the plasma flame is passed over the coating again for additional densification of the coating.

6. The process in accordance with claim 1 wherein mullite with a proportion of 2 to 25 wt. % relative to the oxides (3Al₂O₃.2SiO₂) is used in the sol.

7. The process in accordance with claim 1 wherein the mullite coating is applied to a steel substrate.
